(19) United States
(12) Patent Application Publication
(10) Pub. No.: US 2013/0061810 A1
(43) Pub. Date: Mar. 14, 2013

(54) Bird Feeder

(71) Applicant: Thomas VAN DYK, Ramsey, NJ (US)

(72) Inventor: Thomas VAN DYK, Ramsey, NJ (US)

(21) Appl. No.: 13/550,670

(22) Filed: Jul. 17, 2012

Related U.S. Application Data
(60) Provisional application No. 61/572,739, filed on Jul. 20, 2011.
(60) Provisional application No. 61/636,961, filed on Apr. 23, 2012.

(51) Int. Cl. A01K 39/01

(52) U.S. Cl. 119/61.31

(57) ABSTRACT

A bird feeder includes a fine-mesh inner container positioned in a course-mesh outer container. One or more features within the inner container urge the inner container outwardly against the outer container.

### CROSS-REFERENCED TO RELATED APPLICATIONS

This application claims the benefit of both U.S. Provisional Application No. 61/572,739, filed Jul. 20, 2011, and U.S. Provisional Application No. 61/636,961, filed Apr. 23, 2012. Each of U.S. Provisional Application No. 61/572,739, filed Jul. 20, 2011, and U.S. Provisional Application No. 61/636,961, filed Apr. 23, 2012, is incorporated herein by reference in its entirety.

### BACKGROUND

The present invention relates to bird feeders and, more particularly, to bird feeders that may be used for providing relatively small seeds, such as nyjer (thistle) seeds, to birds. The present invention is not limited to bird feeders that may be used for providing relatively small seeds, such as nyjer (thistle) seeds, to birds.

### BRIEF SUMMARY

One aspect of this disclosure is the provision of a bird feeder having a fine-mesh inner container positioned in a course-mesh outer container. Optionally, the inner container may be urged outwardly against the outer container. For example, one or more features within the inner container may urge the inner container outwardly against the outer container. The inner container may be expandable, and the outwardly urging features may include bird food within the inner container, an insert within the inner container, and/or any other suitable features. The outer container may be at least partially formed from metal wires, and the inner container may be a bag constructed of textile fabric.

The outer container may be an outer wire basket, and the inner container may be a screen or fabric liner that is engaged against the interior of the outer wire basket. Optionally, an insert may be positioned in the liner for urging the liner outwardly against the interior of the outer wire basket. The insert may be a course-mesh inner container, such as an inner wire basket. The outer wire basket, the liner and the inner wire basket may be nested together so that their upper openings are concentric or about concentric. In the nested configuration, bird food may be supplied through the upper opening of the inner wire basket.

For each of the outer wire basket, the liner and the inner wire basket, numerous lateral openings extend therethrough. Typically the lateral openings of the liner are small enough to restrict the bird food from passing therethrough under the force of gravity. In contrast, the lateral openings of the baskets are typically larger than those of the liner. In the nested configuration, birds may reach through lateral openings of the outer wire basket to pull the food through the lateral openings of the liner. More specifically, a majority of (e.g., each of) the lateral openings of the outer wire basket may be larger than a majority of (e.g., each of) the lateral openings of the liner, and a majority of (e.g., each of) the lateral openings of the inner wire basket may be larger than a majority of (e.g., each of) the lateral openings of the outer wire basket. Alternatively, the lateral openings of the inner wire basket may be about the same size as, or smaller than, the lateral openings of the outer wire basket. An upper opening of the outer container may be closed with a lid.

According to one aspect of this disclosure, a bird feeder comprises a container having an upper opening to an interior of the container, and the container comprises a plurality of wires, wherein the plurality of wires comprise at least one wire coiled around wires that extend downwardly from proximate the upper opening. A plurality of openings are defined between the plurality of wires, and the plurality of openings extend through the container. A mesh liner may be positioned in the interior of the container, wherein the mesh liner has a plurality of openings that extend through the mesh liner, from the inner surface of the mesh liner to the outer surface of the mesh liner. The plurality of openings of the mesh liner may be configured for selectively allowing passage of the bird food therethrough. The plurality of openings of the container may be larger than the plurality of openings of the mesh liner. The bird feeder may further include an insert or other suitable feature(s) for at least indirectly urging the mesh liner outwardly, so that the outer surface of the mesh liner is in opposing face-to-face contact with the inner surface of (e.g., substantially all of the inner surface of) the container.

In accordance with one aspect of this disclosure, a bird feeder comprises a container having an upper opening to an interior of the container, and a plurality of lateral openings extending through the container. The liner has a plurality of lateral openings extending through the liner. The plurality of lateral openings of the liner may be configured for selectively allowing passage of the bird food therethrough. The plurality of lateral openings of the container may be larger than the plurality of lateral openings of the liner. An insert may be positioned in the interior of the mesh liner for at least indirectly urging the liner outwardly toward the inner surface of the container. The container may be an outer mesh container, the insert may be an inner mesh container, and the liner may be an intermediate mesh container positioned between the inner and outer mesh containers, so that the inner, outer and intermediate mesh containers are in a nested configuration with one another. The nested configuration may be tight, such that there may be an interference fit between two or more of the inner, outer and intermediate mesh containers.

In accordance with one aspect of this disclosure, a bird feeder comprises an upper opening to an interior of the bird feeder, a lid for opening and closing the upper opening, and first and second mesh materials extending at least partially around the interior of the bird feeder. The first mesh material has a plurality of openings that extend through the first mesh material. The plurality of openings of the first mesh material may be configured for selectively allowing passage of bird food therethrough. The second mesh material has a plurality of openings that extend through the second mesh material. The plurality of openings of the second mesh material may be larger than the plurality of openings of the first mesh material. The second mesh material may support the first mesh material. The outer surface of the first mesh material may be in opposing face-to-face contact with the inner surface of (e.g., substantially all of the inner surface of) the second mesh material. The first mesh material may be a wire mesh material, and the second mesh material may be a textile fabric (e.g., a knitted or other suitable fabric) or any other suitable material.

The bird feeder may further include third mesh material extending at least partially around the interior of the bird feeder. The third mesh material has a plurality of openings that extend through the third mesh material. The plurality of openings of the third mesh material may be larger than the plurality of openings of the first mesh material. The outer surface of the third mesh material may be in opposing face-to-face contact with the inner surface of the first mesh material.

The foregoing presents a simplified summary of some aspects of this disclosure in order to provide a basic understanding. The foregoing is not an extensive summary of the disclosure and is not intended to identify key or critical elements of the invention or to delineate the scope of the invention. The purpose of the foregoing summary is to present some concepts of this disclosure in a simplified form as a prelude to the more detailed description that is presented later. For example, other aspects will become apparent from the following.

### BRIEF DESCRIPTION OF THE DRAWINGS

The drawings are exemplary only, and should not be construed as limiting the invention.

FIG. 1 is a pictorial view of a bird feeder in accordance with an embodiment of this disclosure.

FIG. 2 is a front elevation view of the bird feeder.

FIG. 3 is a right elevation view of the bird feeder.

FIG. 4 is a rear elevation view of the bird feeder.

FIG. 5 is a left elevation view of the bird feeder.

FIG. 6 is a top plan view of the bird feeder.

FIG. 7 is a bottom plan view of the bird feeder.

FIG. 8 is an isolated, top pictorial view of a lined basket of the bird feeder.

FIG. 9 is a side pictorial view of the bird feeder with a lid of the bird feeder positioned for being released from, or releasably attached to, the basket, in accordance with the first embodiment.

FIG. 10 is a schematic, isolated, side, top pictorial view of a removable liner of the bird feeder.

FIG. 11 is a schematic, isolated, side, top pictorial view of an enclosure that may be used in place of the removable liner of FIG. 10, wherein the enclosure includes the removable liner of FIG. 10 that is filled with contents, such as bird food, and upwardly closed by a cover.

FIG. 12 is a bottom pictorial view illustrating that an insert/spring that may optionally be mounted to the inside of the lid of the bird feeder.

FIG. 13 is a schematic cross-sectional view of the closed bird feeder partially filled with bird food, and the spring at least indirectly urging the liner outwardly.

FIG. 14 is an exploded, left side view of the bird feeder including an insert/basket, rather than the spring of FIGS. 12 and 13, for at least indirectly urging the liner outwardly.

FIG. 15 is a front view of the bird feeder in its latched closed configuration.

### DETAILED DESCRIPTION

Exemplary embodiments of this disclosure are described below and illustrated in the accompanying figures, in which like numerals refer to like parts throughout the several views. The embodiments described provide examples and should not be interpreted as limiting the scope of the invention. Other embodiments, and modifications and improvements of the described embodiments, will occur to those skilled in the art and all such other embodiments, modifications and improvements are within the scope of the present invention.

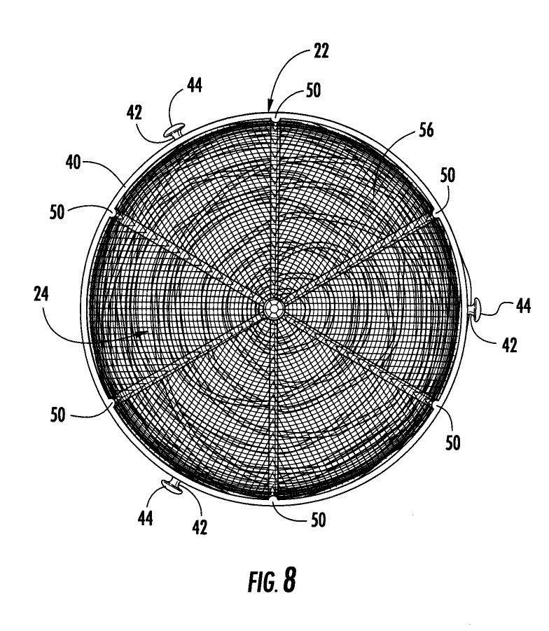

Referring now in greater detail to the drawings, a bird feeder 20 may include an outer coarse-mesh container, such as, but not limited to, a wire basket 22. The basket 22 has a multiplicity of relatively small lateral openings extending therethrough and a relatively large upper opening 24 (FIG. 8). The relatively large upper opening 24 is for providing access to an interior of the bird feeder 20, such as for filling the bird feeder with bird feed. As discussed in greater detail below, the bird feed may be in the form of small seeds, such as nyjer (thistle) seeds, although any suitable bird feed may be used. The bird feeder 20 also includes a closure mechanism, such as, but not limited to, a lid 26, for opening and closing the upper opening 24 of the basket 22. Any suitable lid and/or the like may be used, and the present invention is not limited to the types of lids and associated structures discussed in the following.

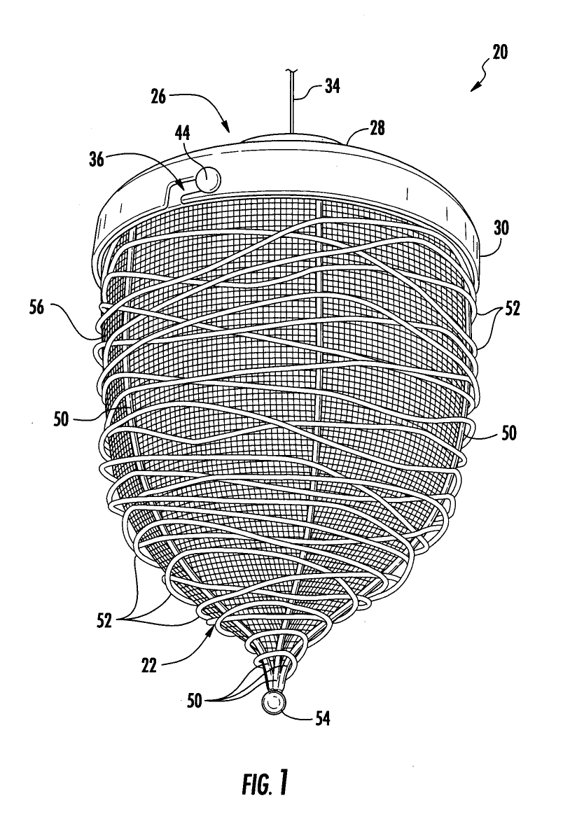

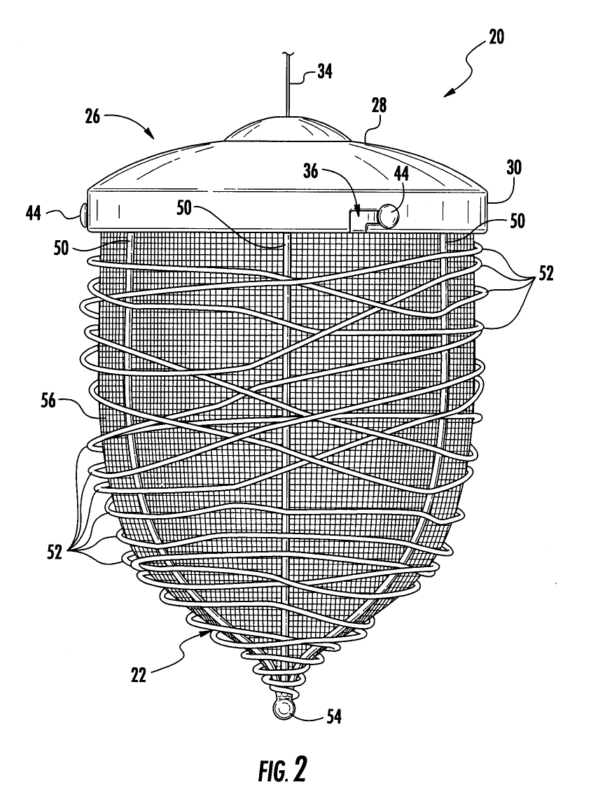

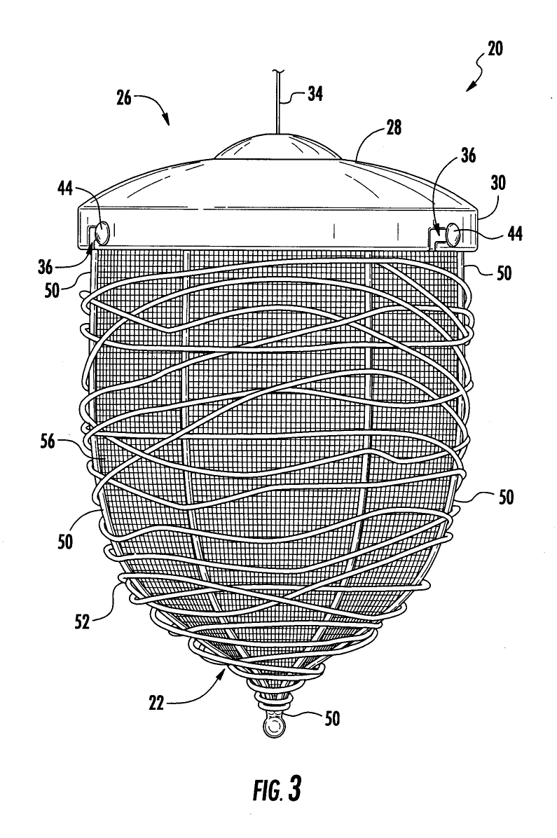

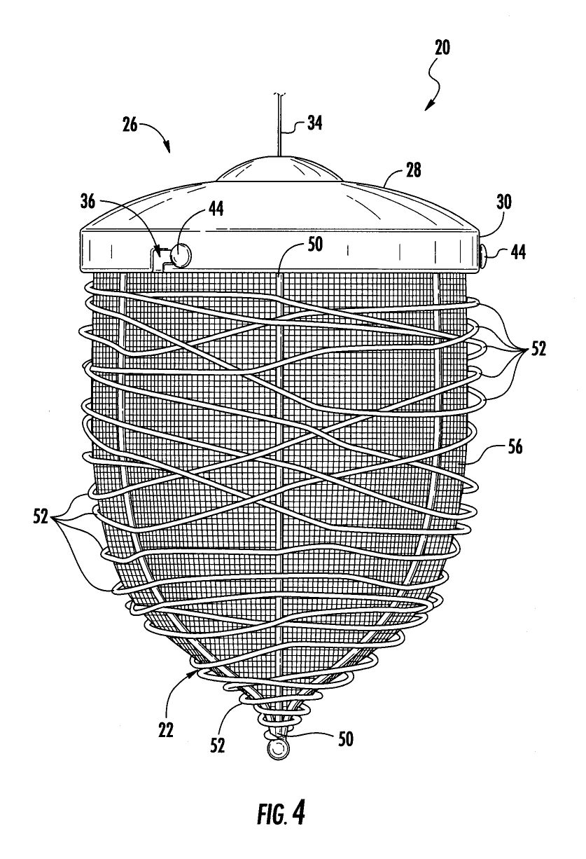

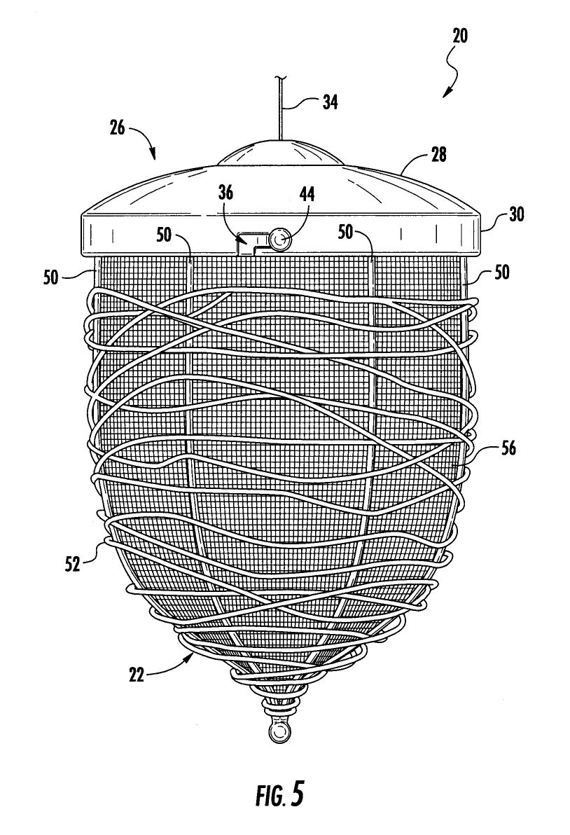

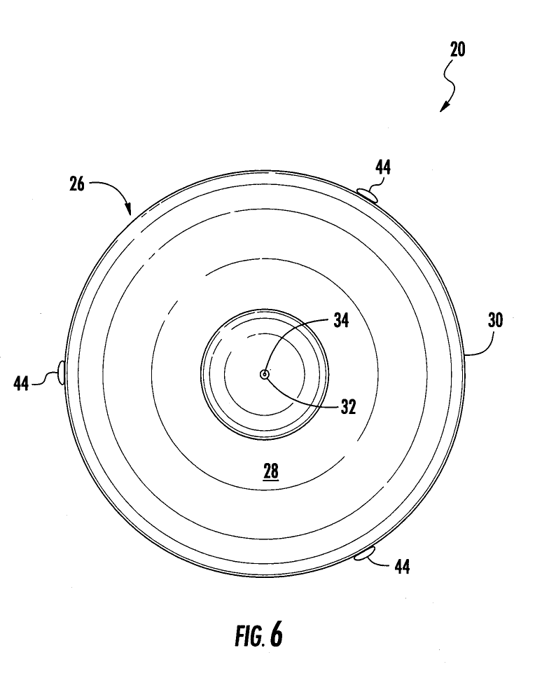

Referring to FIGS. 2-6, the lid 26 may include a domed top wall 28 and an annular outer rim 30 that extends downwardly from the peripheral edge of the top wall. The top wall 28 may include a central hole 32 (FIG. 6) extending therethrough. The top wall 28 extends outwardly and generally downwardly from the central hole 32 so that, for example, any rain drops that fall on the lid 26 will tend to flow downwardly and away from the central hole 32. A hanging mechanism may extend upwardly through the central hole 32, for use in hanging the bird feeder. Any suitable hanging mechanism may be used, or the bird feeder may sit on a stand. For example, the hanging mechanism may be in the form of a suitable wire, chain, string 34 (e.g., braded wire string or rope), or the like, having a lower end that extends downwardly through the central hole 32. The upper portion of the string 34 is cut away in FIGS. 1-6. The periphery of the central hole 32 may engage tightly around the string and/or the central hole may otherwise be plugged in a manner that seeks to prevent, for example, water or any other unwanted substance or items from passing through the central hole. The portion of the string 34 below the central hole in the lid 26 is secured or otherwise configured for restricting the lower end of the string from passing through the central hole. For example, the lower end of the string 34 may be tied into a knot that is too large to pass through the central hole 32, or the lower end may be tied to one or more structures that are too large to pass through the central hole 32, as will be discussed in greater detail below.

More specifically, the top wall 28 may be in the form of a two-tiered dome top wall, with a relatively small inner domed portion and a relatively large outer domed portion. The domed portions, central hole 32 and outer rim 30 are coaxial (e.g., substantially coaxial), although differently configured lids are within the scope of this disclosure.

The outer rim 30 may include attachment features, such as, but not limited to, compound slots 36, for use in attaching the lid 26 to the basket 22. There may be three of the compound slots 36 that each have a downwardly open axial slot and an arcuate slot that extends partially around the outer rim 30 from the respective axial section. The axial slots extend along the common axis of the lid's domed portions, central hole 32 and outer rim 30. For each compound slot 36, both of the axial and arcuate slots are at least partially defined by a cantilevered arcuate portion of the outer rim 30.

Referring to FIG. 8, the basket 22 may include a band or annular inner rim 40, and attachment features fixedly connected to and extending outwardly from the inner rim. The attachment features of the basket 22 may be in the form of shafts 42 that are fixedly connected to, and extend outwardly from, the inner rim 40 for being respectively received in/respectively extending through the compound slots 36 defined in the outer rim 30. Each of the shafts 42 may optionally include/terminate at an outer head 44 having a larger diameter than the shaft.

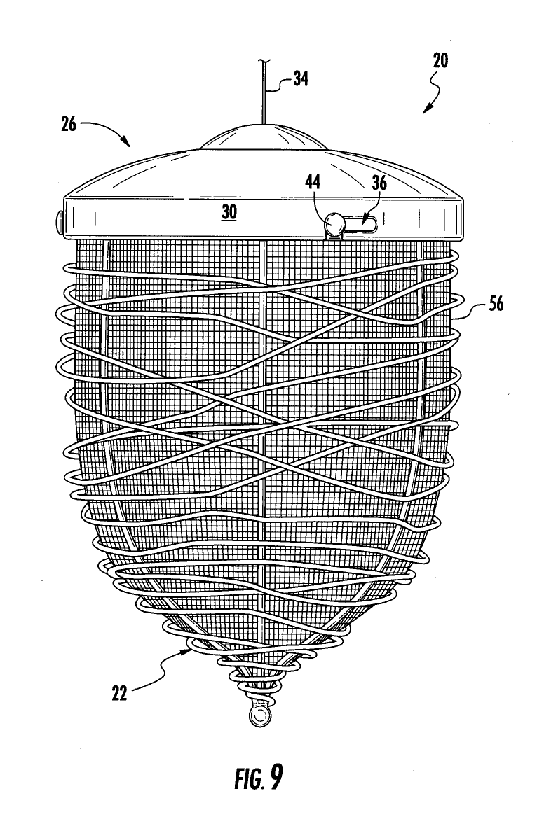

Referring to FIG. 9, the upper opening 24 (FIG. 8) of the basket 22 may be closed by manually causing axial relative movement between the basket 22 and the lid 26 so that the outer rim 30 extends around the inner rim 40 (FIG. 8) and the shafts 42 (FIG. 8) are respectively received into the axial slots of the compound slots 36, and then manually causing relative rotation between the basket and lid so that the shafts are respectively received into the arcuate slots of the compound slots 36. The upper opening 24 of the basket 22 may be opened by reversing the steps described above. The position of the attachment features 36, 42 of the lid 26 and basket 22 may be reversed and/or the attachment features 36, 42 may be replaced with any other suitable attachment features. For example, the attachment features 36, 42 may be replaced with helical thread structures respectively formed in or carried by the rims 30, 40, so that the lid 26 may be screwed onto, and then off of, the basket 22. As another example, the attachment features may be replaced with a hinge and a manually operable latch, wherein the hinge may include plates pivotably connected to one another by way of a pivot pin, and the plates are respectively mounted to the rims 30, 40, such as by welding or any other suitable fastening technique; and wherein the latch may include a protruding member or keeper mounted to one of the rims 30, 40 and a hasp or clasp pivotably connected to the other of the rims 30, 40 and having a receptacle (e.g., opening) for releasably receiving the keeper. Any other suitable attachment features may be used.

Whereas the basket 22 may be any suitable type of container that may be constructed in any suitable manner, the basket 22 shown in the drawings is constructed of generally axially extending and generally arcuately extending wires 50, 52 that may be respectively woven together and/or otherwise respectively connected, and are supported by the inner rim 40. The wires 50, 52 may form or be part of a wire mesh material that extends at least partially around, or more specifically all the way around, the interior of the basket 22. More specifically, the basket 22 may include generally axially extending, inner wires 50 having upper ends that are fixedly mounted to the inner rim 40 at positions spaced apart around the periphery of the inner rim, and lower ends that extend convergently toward the lower end of the basket. More specifically, the lower ends of the inner wires 50 may be fixedly jointed together at a lower point, or ball-shaped terminus 54, of the basket. The terminus 54 may be approximately coaxial with the inner rim 40 and upper opening 24 of the basket 22.

At least one (e.g., one or more) generally annularly and generally arcuately and helically extending outer wire 52 extends around (e.g., is wrapped and coils around) the group of inner wires 50. In addition, some of the coils, portions of the coils and/or groups of the coils of the outer wire 52 may extend back and forth along the axis of the basket 22, so that there is overlapping between the coils, portions of the coils and/or groups of the coils of the outer wire 52 with respect to one another. For example, the outer wire 52 may be characterized as being arranged in a helix that is superposed with a zig zag and/or undulations. The opposite ends of the inner wires 50 may be fixedly mounted such as by welds, or by way of any other suitable attachment. Similarly, the outer wire(s) 52 may be (occasionally/optionally) fixedly connected to the inner wires 50 wherever they cross, and the outer wire may be (occasionally/optionally) fixedly connected to itself wherever sections of it cross one another. The connections of the wires 50, 52 may be formed with welding, or by way of any other suitable means. Alternatively, one or more of the outer wire(s) 52 may be positioned inwardly of the inner wires 50, and/or the wires may be arranged any other suitable configuration, such as in a woven configuration. The wires 50, 52 of the basket 22 are not required to be woven with respect to one another; however, they may optionally be woven. That is, it is within the scope of this disclosure for a basket to be constructed with and/or without weaving. The crossing of the wires 50, 52 defines numerous relatively large side and lower openings of the basket 22, and these openings may be referred to as lateral openings. Whereas the basket 22 and lid 26 may be made of metal, they may alternatively be made of any other suitable material, such as polymeric material, and they may be injection molded or formed in any other suitable manner.

The interior of the basket 22 is typically lined with an inner fine-mesh container or liner 56 that defines relatively small lateral openings that are smaller than the relatively large lateral openings of the basket 22. That is, one aspect of this disclosure comprises a method of assembling the bird feeder 20, and the method comprises lining the basket 22 with the liner 56. The liner 56 may be formed of a mesh material that extends at least partially around, or more specifically all the way around, the interior of the liner. The plurality of relatively small openings of the liner 56 are configured for selectively allowing passage of the bird food therethrough. Stated differently, the relatively small openings of the liner 56 typically are, but are not limited to, openings sized for dispensing therethrough relatively small seeds, such as nyjer (thistle) seeds, to birds. The outer surface of the liner 56 may be in opposing face-to-face contact with the inner surface of (e.g., substantially all of the inner surface of) the basket 22.

The liner 56 may be formed from any suitable mesh material. For example, the liner 56 may be constructed of nylon mesh material, such as that sold as conventional finch socks or as a precursor to conventional finch socks. As a more specific example, the liner 56 may be a tubular piece of textile fabric (e.g., knitted fabric, nylon mesh, or any other suitable fabric) with a lower end that has been knitted or sewn closed. The liner 56 may be a lower portion of a conventional finch sock. In one specific example, the liner 56 is a bag constructed of an open-mesh textile fabric (e.g., conventional finch sock material), and the wires 50, 52 are metal. In this regard and at one level of abstraction, a bird feeder 20 in accordance with one embodiment of this disclosure may provide the benefits associated with the usage of finch sock material, wherein those benefits are enhanced by the support and/or protection provided by the basket 22 and lid 26, without detracting from the benefits associated with the usage of finch sock material. Notwithstanding the specific example provided above, other features, materials, arrangements and advantages are within the scope of this disclosure.

As another example, the liner 56 may be formed from a wire mesh material, such as that sold as conventional window screening. The wire mesh liner 56 may include numerous laterally spaced apart longitudinally extending wires, and numerous longitudinally spaced apart laterally extending wires that are woven together. For example, the wire mesh liner 56 may optionally be fixedly mounted to the basket 22, such as by being welded and/or attached in any other suitable manner to the basket. As a more specific example, the liner 56 may be formed by welding several generally pie-shaped pieces of the mesh to the basket 22. Accordingly, the liner 56 may be characterized as being part of the basket 22.

As another example, the liner 56 may be manually removable from the basket 22, and it may be held open and maintained proximate (e.g., engaged against) the interior surface of the basket 22 in any suitable manner, such as by way of one or more features that are within the liner. Typically the liner 56 is engaged against each of the inner wires 50, for substantially the entire length of the inner wires, and the liner 56 may also be engaged against at least portions of the outer wire 52 that span between the inner wires, so that the liner 56 is proximate and/or may at least partially define the exterior of the bird feeder 20.

The upper portion of the basket 22 may be generally cylindrical, and the lower portion of the basket may gradually taper to a conical shape. The overall shape may generally resemble a pine cone, an acorn, a tube and/or any other suitable shape. Accordingly, the liner 56 typically has substantially the same shape as, and a slightly smaller size than, the basket 22 and/or the liner is constructed of an expandable/deformable material for confirming to the shape of the basket. Whereas the liner 56 may be fixedly attached to the basket 22, as mentioned above, the liner may, in another example, be removably attached to the basket, or even loosely placed in the basket. The liner 56 may be urged outwardly against the basket. For example, one or more features within the liner 56 may urge the liner outwardly against the basket. The liner 56 may be expandable, and the outwardly urging features may include bird food within the liner, an insert within the liner, and/or any other suitable features. For example, the liner 56 within the basket 22 may be filled with bird food, such as, but not limited to, nyjer (thistle) seeds and/or a liner previously filled with such bird food may be placed in the basket. Then, the upper opening of the basket 22 may be closed with the lid 26, and the bird feeder may be suspended by way of the string 34 or any other suitable hanging or suspending mechanism. Then, birds may use their beaks to pull the bird food through the openings of the liner 56 and basket 22 for consumption.

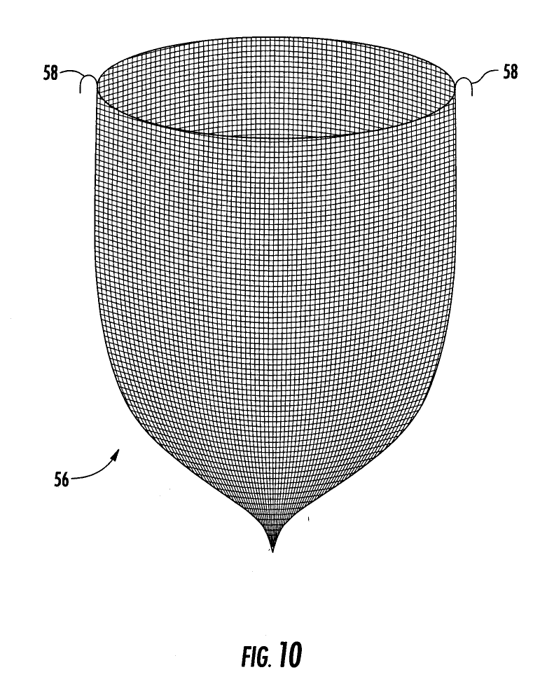

As mentioned above, the liner 56 may be removable from the basket 22, and FIG. 10 schematically illustrates the removed liner in isolation. The liner 56 typically has a multiplicity of relatively small lateral openings (e.g., for dispensing bird food) that extend through the liner. The removable liner 56 may generally be in the form of an upwardly open container, bag, or the like, optionally having substantially the same shape as, and optionally being slightly smaller in size than, the basket 22. FIG. 10 may be schematic, for example, because the liner 56 may be constructed of a flexible material that does not take on the shape of the basket 22 until, for example, the liner is within the basket and urged outwardly.

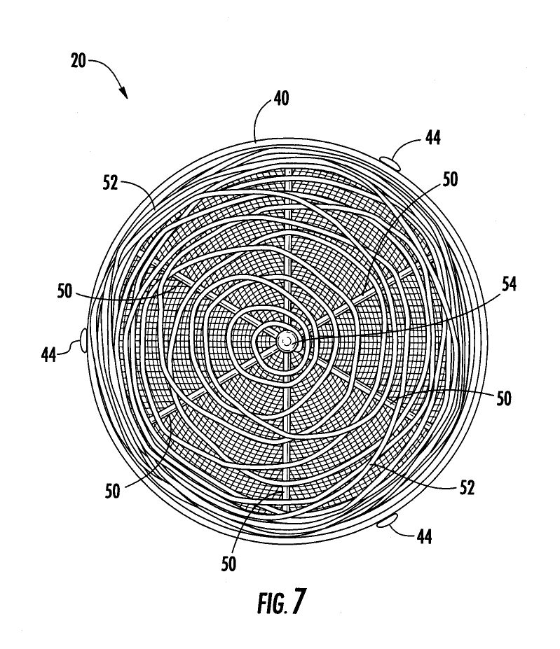

The removable liner 56 may be removably mounted in the basket 22. In one example, the basket 22 is self-supporting, such that it is sufficiently rigid to substantially maintain its shape. In contrast, the liner 56 may not be self-supporting, and the liner may be supported or held in its open shape by the basket 22 in combination with other features. Reiterating from above, one or more features within the liner 56 may urge the liner outwardly against the basket 22. Alternatively and/or additionally, the removable liner 56 may optionally include attachment features such as, but not limited to, clips, hooks 58 or other suitable releasable fasteners that protrude outwardly from its upper periphery, for releasably fitting over the upper edge of the inner rim 40 of the basket 22. There may be more or less of the fasteners (e.g., hooks 58). For example, there may be numerous of the fasteners (e.g., hooks 58) fixedly connected around the upper periphery of the removable liner 56. As another example, the hooks 58 may be schematically illustrative of the annular, upper peripheral margin of the liner 56 being folded outwardly over the upper edge of the rim 40 (FIGS. 7 and 8) of the basket 22.

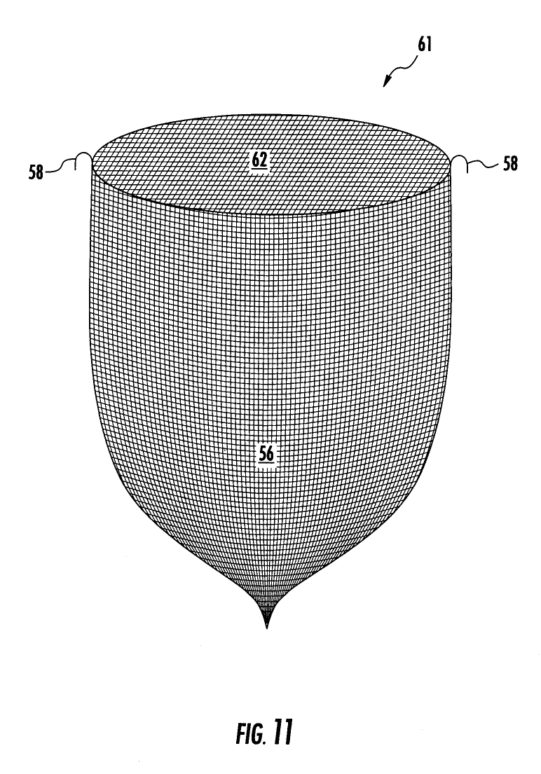

Referring to FIG. 11, an enclosure 61 may be substituted for the upwardly open, removable liner 56 discussed above. The enclosure 61 may be a replacement item supplied (e.g., purchased by consumers) with the bird food (or other contents) enclosed therein. An upright wall 56 of the enclosure 61 may be in the form of the removable liner 56, and the upright wall forms a container that is filled with contents, such as bird food, and upwardly closed by a cover 62. FIG. 11 may be schematic, for example, because the enclosure 61 may be constructed of a flexible material that does not take on the shape of the basket 22 until the enclosure is within the basket. The sidewall 56 of the enclosure 61 typically has a multiplicity of relatively small lateral openings (e.g., for dispensing bird food) that extend through the side wall 56. Optionally, the cover 62 may be constructed of the same material as the side wall 56, such that the cover may have a multiplicity of relatively small lateral openings (e.g., for dispensing bird food) that extend therethrough.

In one example, the container formed by the upright side wall 56 of the enclosure 61 is filled with the bird food (or other contents) and then the cover 62 is mounted (e.g., fixedly mounted) to the upper periphery of the upright wall 56 of the enclosure 61 to close (e.g., fixedly close) the upper opening of the container defined by upright wall 56 of the enclosure 61. For example, the cover 62 may be constructed of the same material as the liner 56/upright wall 56 of the enclosure 61, and the cover 62 may be mounted to the upright wall 56 of the enclosure 61 in any suitable manner, such as by welding, fasteners, stitching and/or in any other suitable manner depending upon the material from which the upright wall 56 and cover 62 of the enclosure 61 are constructed. Each time the bird food (or other contents) are depleted from the enclosure 61 within the bird feeder 20, the bird feeder may be opened and the enclosure 61 may be replaced with a replacement enclosure 61 that is full of food (or other contents), and the removed enclosure 61 may optionally be discarded, recycled or refilled.

The attachment features 36, 42, 58, or variations thereof, may be adapted in a manner that seeks to ensure that the proper liners 56 or enclosures 61 are used in the bird feeder 20. One or more of (e.g., each of) the attachment features 36, 42, 58 may be omitted, and other types of attachment features, or the like, may be incorporated into the bird feeder 20, as will be discussed in greater detail below.

At least one insert (e.g., biasing and/or attachment feature) may be positioned in, or is positionable in, the basket 22 (e.g., positionable in the liner 56) for urging at least a portion of the liner 56 and/or at least some of the bird food (or other contents) in the basket at least outwardly and perhaps also forcing the bird food (or other contents) in the basket upwardly in a manner so that, as the amount of bird food in the basket is reduced by the birds' consumption, the level of the bird food adjacent to the liner 56, upright wall 56 or other suitable outer structure is greater than the level of the bird food along (e.g., at) the axis of the basket. This maximizing of the bird food adjacent to the liner 56, upright wall 56 or other suitable outer structure seeks to optimize the amount of bird food that remains available to the birds along the liner 56, upright wall 56 or other suitable outer structure.

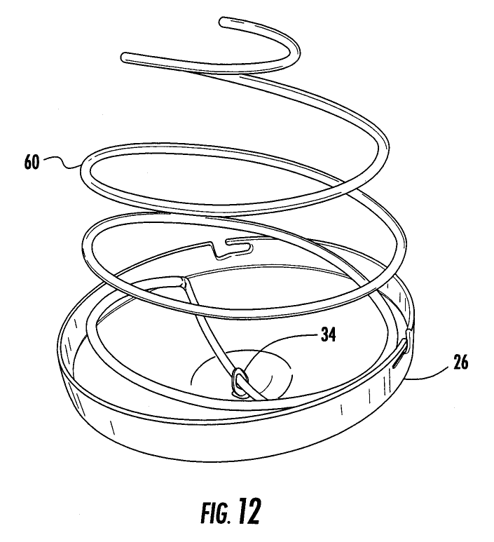

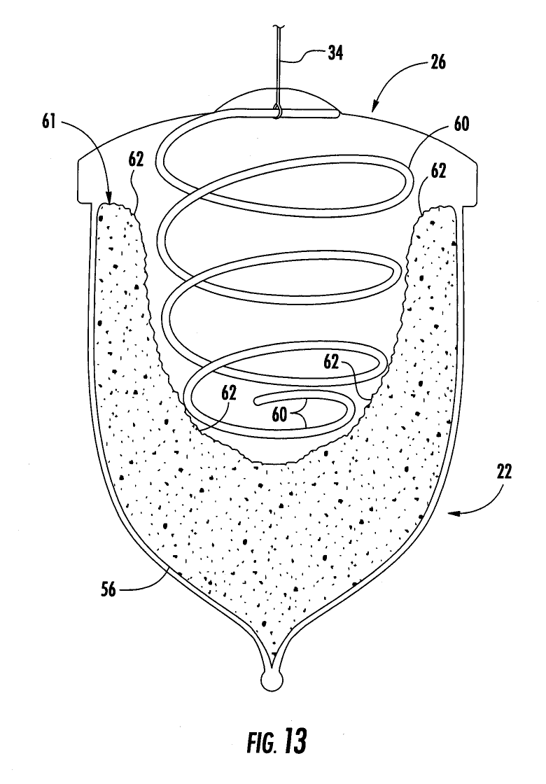

Referring to FIGS. 12 and 13, the optional insert and/or biasing feature may, for example, be in the form of a spring 60 mounted to, and carried by, the lid 26. The spring 60 may be in the form of a helical wire spring having a bent or otherwise configured upper arm that extends toward and/or substantially across the axis of the spring, and coils of lesser diameter in the axial direction away from the lid 26. For at least partially mounting the spring 60 to the lid 26, the lower end of the string 34 may extend through the hole 32 in the lid and be tied to the upper arm of the spring 60. While the spring 60 is fully expanded and coaxially positioned in the basket 22, the overall shape of the spring generally corresponds to the shape of the basket, except that the overall shape of the spring may be smaller that the overall shape of the basket 22 and enclosure 61, so that a gap is defined between the side wall 56 of the enclosure and the spring. In this regard, the spring 60 may be operative for at least indirectly urging the liner 56 outwardly so that the outer surface of the liner is in opposing face-to-face contact with the inner surface of (e.g., substantially all of the inner surface of) the basket 22. Alternatively, the spring may be in opposing face-to-face contact with the inner surface of the liner 56 so that the outer surface of the liner is in opposing face-to-face contact with the inner surface of (e.g., substantially all of the inner surface of) the basket 22.

The bird food is schematically illustrated by stippling in FIG. 13. As best understood with reference to FIG. 13, with the enclosure 61 full of bird feed and closed within the bird feeder 10, the spring 60 is compressed between the inner surface of the top wall 28 of the lid 26 and the cover 62 of the enclosure. As the content of the bird feed is reduced, the spring 60 expands and pushes the central portion of the cover 62 downwardly. At least in theory, the pushing by the spring 60 may be directed in a manner that seeks to force at least some of the remaining bird feed in the enclosure 61 outwardly and perhaps also upwardly within the enclosure 61 so that the level of the bird food adjacent to the upright wall 56 is greater than the level of the bird food along (e.g., at) the axis of the basket 20, as schematically shown in FIG. 13, wherein the bird feed (e.g., nyjer (thistle)) seeds, or other contents, are schematically illustrated by stippling. If necessary or desired, the cover 62 of the enclosure 61 may be made of a flexible material so that the cover is deformed under the force of the expanding spring 60, as schematically shown in FIG. 22. For example and not limitation, the cover 62 of the enclosure 61 may be made of a flexible membrane, an elastic fabric, a knitted fabric, a flexible latex membrane and/or any other suitable material for being stretched or otherwise deformed and forced into the interior of the lower portion of the enclosure 61.

Other types of inserts may be provided for forcing the liner 56 and/or bird food outwardly and/or upwardly. For example, the spring 60 may include any suitable broad structure (e.g., a diaphragm) at its lower end for forcing the bird food or other contents outwardly and upwardly. The spring 60 is optional and may be omitted or replaced with another suitable insert, as discussed in greater detail below.

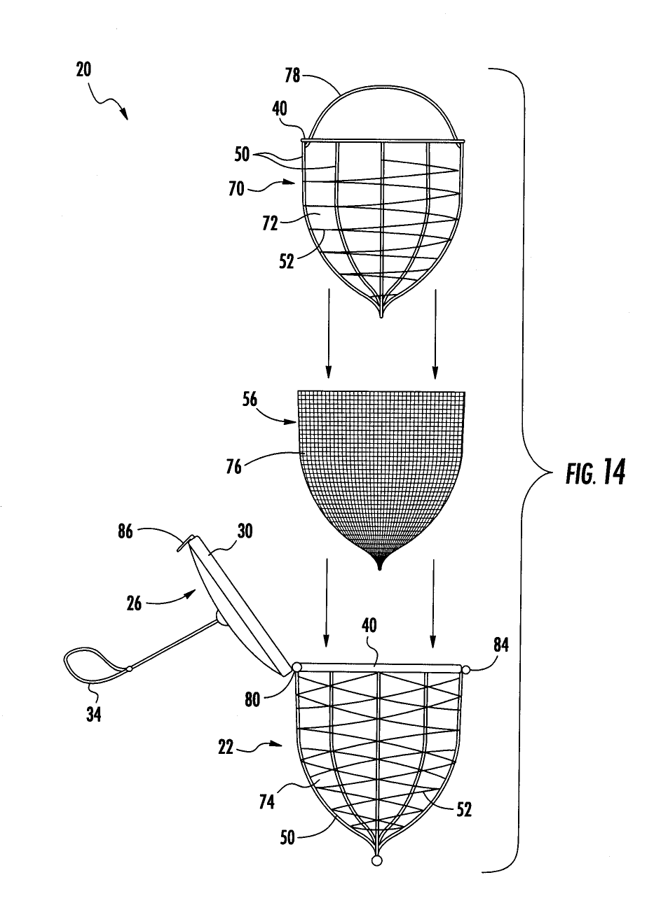

Referring to FIG. 14, the upwardly open liner 56 may removably fit into the outer basket 22, and an insert member such as, but not limited to, an inner basket 70 may removably fit into the liner for urging the liner outwardly (e.g., holding the liner open and in an expanded configuration) and maintaining the liner proximate (e.g., against) the interior surface of the outer basket 22, even when the bird feeder is fully or partially empty of bird food. The inner basket 70 may be more generally referred to as an inner course-mesh container that may be constructed of any suitable material. One aspect of this disclosure comprises a method assembling the bird feeder 20, and the method may include positioning the insert/inner basket 70 in the liner 56 for at least indirectly urging the liner outwardly toward the inner surface of the outer basket 22. The inner basket 70 may be inserted into and/or covered with the liner 56 either before or after the outer basket 22 is lined with the liner 56.

The inner basket 70 may be formed of a mesh material that extends at least partially around, or more specifically all the way around, the interior of the inner basket 70. The outer surface of (e.g., substantially all of the outer surface of) the inner basket 70 may be in opposing face-to-face contact with the inner surface of the liner 56.

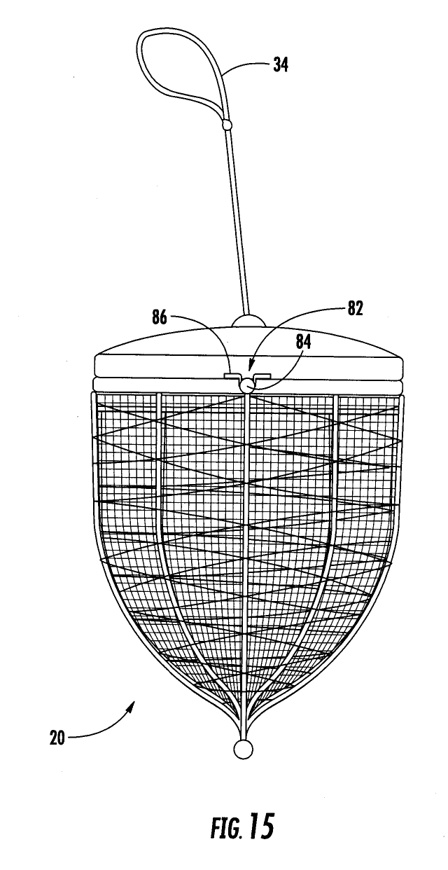

The inner basket 70 may be like the outer basket 22, except, for example, for being slightly smaller to facilitate the nesting together of the baskets 22, 70 and liner 56, so that the liner (e.g., at least the upper portion of the liner) is held (e.g., pinched) securely in place between the baskets 22, 70 when the baskets 22, 70 and liner 56 are nested together as shown in FIG. 15. For example, the annular upper edge of the liner 56 may be held (e.g., pinched) securely in place between the rim 40 of the inner basket 70 and the rim 40 of the outer basket 22. The close fitting of the liner 56 between the baskets 22, 70 may provide an interference fit for at least partially mounting (e.g., for removably mounting) the liner to the outer basket 22 and/or the inner basket 70. Accordingly, the inner basket may optionally be referred to as a means for mounting the liner 56 to the outer basket 22. The baskets 22, 70 may each be self-supporting, such that each is sufficiently rigid to substantially maintain its shape. In contrast, the liner 56 may not be self-supporting, and the liner may be supported or held in its open shape by the baskets 22, 70.

Bird food, such as, but not limited to, nyjer (thistle) seeds may be poured into the upper opening of the inner basket 70 while the baskets 22, 70 and liner 56 are nested together and the lid 26 is open, so that the liner 56 contains the bird food. Then, the upper opening of the outer basket 22 may be closed with the lid 26, and the bird feeder may be suspended by way of the string 34 or any other suitable hanging or suspending mechanism. Then, birds may use their beaks to pull the bird food through the openings of the liner 56 and outer basket 22 for consumption. The annular upper edge of the liner 56 being pinched and held securely in place between the rim 40 of the inner basket 70 and the rim 40 of the outer basket 22 seeks to prevent the liner from sagging in a manner that may allow the bird food to spill out of the upper opening of the liner, such as during the filling of the bird feeder and/or as the birds empty the bird food from the bird feeder.

Reiterating from above, the inner basket 70 may be generally like the outer basket 22. Accordingly, the inner basket 70 may include an arcuately extending wire 52 coiled around (e.g., extending substantially helically around) the axially extending wires 50 of the inner basket. Alternatively, the inner basket 70 may include multiple arcuately extending wires 52 extending substantially helically around the axially extending wires 50 of the inner basket. As another example, the axially extending wires 50 of the inner basket 70 may be joined together at a tip without including a ball-shaped terminus 54. The lateral openings 72 extending through the inner basket 70 may be larger than the lateral openings 74 extending through the outer basket 22, and the lateral openings extending through the outer basket 22 are typically larger than the lateral openings 76 extending through the liner 56. A pivotable wire handle 78 may have opposite ends connected to opposite portions of the wire rim 40 of the inner basket 70. The handle 78 may be configured differently or be omitted.

Referring to FIG. 14, the spring 60 may be omitted from the lid 26, and the lid may be pivotably connected to the outer basket 22 by a hinge 80. The hinge 80 may include plates pivotably connected to one another by way of a pivot pin, and the plates may be respectively mounted to the rims 30, 40 of the lid 26 and outer basket 22, such as by welding or any other suitable fastening technique.

A latch 82 may be positioned opposite the hinge 80 for releasably securing the lid 26 in its closed configuration shown in FIG. 15. The latch 82 may include a protruding member or keeper 84 fixedly connected to the rim 40 of the outer basket 22, and a hasp or clasp 86 pivotably connected the rim 30 of the lid 26. The clasp has a receptacle (e.g., opening) for releasably receiving the keeper 84. The positions of the keeper 84 and clasp 86 may be reversed, and any other suitable attachment features may be used.

Referring to FIGS. 14 and 15 and at least partially reiterating from above, in one specific example, the liner 56 is a bag constructed of an open-mesh textile fabric (e.g., conventional finch sock material), and the wires 50, 52 are metal. In this regard and at one level of abstraction, a bird feeder 20 in accordance with one embodiment of this disclosure may provide the benefits associated with the usage of finch sock material, wherein those benefits are enhanced by the support and/or protection provided by the baskets 22, 70 and lid 26, without detracting from the benefits associated with the usage of finch sock material.

Although the above disclosure has been presented in the context of exemplary embodiments, it is to be understood that modifications and variations may be utilized without departing from the spirit and scope of the invention, as those skilled in the art will readily understand. For example, features of this disclosure may be in various combinations and subcombinations beyond those discussed above. The above examples are in no way intended to limit the scope of the present invention. It will be understood by those skilled in the art that while the present disclosure has been discussed above with reference to exemplary embodiments, various additions, modifications and changes can be made thereto without departing from the spirit and scope of the invention as set forth in the claims.

What is claimed is:

1. A bird feeder for dispensing food to birds, the bird feeder comprising:
a container comprising
an upper opening to an interior of the container, and
a plurality of lateral openings, the plurality of lateral openings extending through the container, from an inner surface of the container to an outer surface of the container;
a lid for opening and closing the upper opening;
a liner positioned in the interior of the container, the liner comprising
an upper opening to an interior of the liner, and
a plurality of lateral openings, the plurality of lateral openings extending through the liner, from an inner surface of the liner to an outer surface of the liner, wherein the plurality of lateral openings of the liner are configured for selectively allowing passage of the bird food therethrough, and the plurality of lateral openings of the container are larger than the plurality of lateral openings of the liner; and
an insert is positioned in the interior of the liner, the insert at least indirectly urging the liner outwardly toward the inner surface of the container.

2. The bird feeder according to claim 1, wherein:
the container is a mesh container comprising metal wires; and
the liner comprises a bag constructed of textile fabric.

3. The bird feeder according to claim 1, wherein:
the container is an outer mesh container;
the insert is an inner mesh container; and
the liner is an intermediate mesh container positioned between the inner and outer mesh containers, so that the inner, outer and intermediate mesh containers are in a nested configuration with one another.

4. The bird feeder according to claim 1, wherein the insert is at least indirectly urging the liner outwardly so that the outer surface of the liner is in opposing face-to-face contact with the inner surface of the container.

5. The bird feeder according to claim 1, wherein the insert comprises a spiral wire.

6. The bird feeder according to claim 1, in combination with the bird food, wherein the bird food is positioned in the interior of the mesh liner.

7. A bird feeder for dispensing food to birds, the bird feeder comprising:
a container having an upper opening to an interior of the container, and the container comprising a plurality of wires, wherein the plurality of wires comprise wires extending downwardly from proximate the upper opening, and at least one wire coiled around the wires that extend downwardly from proximate the upper opening, and wherein a plurality of openings are defined between the plurality of wires, and the plurality of openings extend through the container, from an inner surface of the container to an outer surface of the container;
a lid for opening and closing the upper opening; and
a mesh liner positioned in the interior of the container, the mesh liner having opposite inner and outer surfaces, the mesh liner having a plurality of openings that extend through the mesh liner, from the inner surface of the mesh liner to the outer surface of the mesh liner, wherein the plurality of openings of the mesh liner are configured for selectively allowing passage of the bird food therethrough, the plurality of openings of the container are larger than the plurality of openings of the mesh liner, and the outer surface of the mesh liner is in opposing face-to-face contact with the inner surface of the container.

8. The bird feeder according to claim 7, wherein the mesh liner comprises a bag constructed of textile fabric.

9. The bird feeder according to claim 7, wherein:
the container comprises a lower end opposite the upper opening; and
the wires that extend downwardly from proximate the upper opening extend convergently toward the lower end.

10. The bird feeder according to claim 7, wherein:
the container comprises an upper rim; and
the wires that extend downwardly from proximate the upper opening are connected to the upper rim.

11. The bird feeder according to claim 10, wherein:
the container comprises terminus at a lower end of the container;
the wires that extend downwardly from proximate the upper opening extend convergently toward the terminus; and
the wires that extend downwardly from proximate the upper opening are connected to the terminus.

12. The bird feeder according to claim 7, further comprising means for mounting the mesh liner in the interior of the container.

13. The bird feeder according to claim 7, further comprising an insert, wherein:
the mesh liner has an upper opening to an interior of the mesh liner;
the insert is positioned in the interior of the mesh liner; and
the insert is configured for at least indirectly urging the mesh liner outwardly so that the outer surface of the mesh liner is in opposing face-to-face contact with the inner surface of the container.

14. The bird feeder according to claim 13, wherein the insert comprises a spiral wire.

15. The bird feeder according to claim 13, in combination with the bird food, wherein the bird food is positioned in the interior of the mesh liner.

16. A bird feeder for dispensing food to birds, the bird feeder comprising:
an upper opening to an interior of the bird feeder;
a lid for opening and closing the upper opening;
first mesh material extending at least partially around the interior of the bird feeder, the first mesh material having opposite inner and outer surfaces, the first mesh material having a plurality of openings that extend through the first mesh material, from the inner surface of the first mesh material to the outer surface of the first mesh material, wherein the plurality of openings of the first mesh material are configured for selectively allowing passage of the bird food therethrough; and
second mesh material extending at least partially around the interior of the bird feeder, the second mesh material having opposite inner and outer surfaces, the second mesh material having a plurality of openings that extend through the second mesh material, from the inner surface of the second mesh material to the outer surface of the second mesh material, wherein the plurality of openings of the second mesh material are larger than the plurality of openings of the first mesh material, the second mesh material supports the first mesh material, and the outer surface of the first mesh material is in opposing face-to-face contact with the inner surface of the second mesh material.

17. The bird feeder according to claim 16, wherein the first mesh material comprises:
a plurality of wires extending downwardly from proximate the upper opening; and
at least one wire coiled around the plurality of wires.

18. The bird feeder according to claim 17, comprising a lower end opposite the upper opening, wherein the plurality of wires extend convergently toward the lower end.

19. The bird feeder according to claim 16, wherein:
the first mesh material is a wire mesh material; and
the second mesh material is a textile fabric.

20. The bird feeder according to claim 19, wherein the textile fabric is a knitted fabric.

21. The bird feeder according to claim 16, further comprising third mesh material extending at least partially around the interior of the bird feeder, the third mesh material having opposite inner and outer surfaces, the third mesh material having a plurality of openings that extend through the third mesh material, from the inner surface of the third mesh material to the outer surface of the third mesh material, wherein the plurality of openings of the third mesh material are larger than the plurality of openings of the first mesh material, and the outer surface of the third mesh material is in opposing face-to-face contact with the inner surface of the first mesh material.

22. The bird feeder according to claim 21, wherein the first mesh material comprises:
a plurality of wires extending downwardly from proximate the upper opening; and
at least one wire coiled around the plurality of wires.

23. The bird feeder according to claim 22, comprising a lower end opposite the upper opening, wherein the plurality of wires extend convergently toward the lower end.

24. A method of at least assembling a bird feeder, comprising:
lining an outer mesh container with a mesh liner, wherein
the outer mesh container comprises a plurality of lateral openings that extend through the outer mesh container, from an inner surface of the outer mesh container to an outer surface of the container,
the mesh liner comprises a plurality of lateral openings that extend through the mesh liner, from an inner surface of the mesh liner to an outer surface of the mesh liner,
the plurality of lateral openings of the mesh liner are configured for selectively allowing passage of bird food therethrough,
the plurality of lateral openings of the outer mesh container are larger than the plurality of lateral openings of the mesh liner, and
the lining of the outer mesh container with the mesh liner comprises
arranging the mesh liner in an interior of the outer mesh container, and
engaging the outer surface of the mesh liner against the inner surface of the outer mesh container.

25. The method according to claim 24, further comprising positioning an insert in the liner for at least indirectly urging the mesh liner outwardly toward the inner surface of the outer mesh container.
